(19) United States
(12) Patent Application Publication
(10) Pub. No.: US 2026/0146384 A1
(43) Pub. Date: May 28, 2026

(54) FLAME RETARDANT SYSTEM FOR CELLULOSE-BASED TEXTILES

(71) Applicant: BROMINE COMPOUNDS LTD., Beer-Sheva (IL)

(72) Inventors: Ella RAPAPORT, Moshav Shahar (IL); Iris BEN DAVID, Ashdod (IL); Dov BERBUEN, Beer-Sheva (IL); Orel AMAR, Ofakim (IL); Yelena EPSHTEIN ASSOR, Beer Sheva (IL); Itzhak SHALEV, Beit Gamliel (IL)

(21) Appl. No.: 19/124,099

(22) PCT Filed: Oct. 26, 2023
(86) PCT No.: PCT/IL2023/051109

§ 371 Date: Apr. 24, 2025

Related U.S. Application Data
(60) Provisional application No. 63/419,742, filed on Oct. 27, 2022.

(51) Int. Cl. D06M 13/298; C08K 5/521; D06M 10/10; D06M 13/256; D06M 15/263; D06M 15/423; D06M 101/06; D06M 101/16

(52) U.S. Cl. CPC D06M 13/298; C08K 5/521; D06M 10/10; D06M 13/256; D06M 15/263; D06M 15/423; D06M 2101/06; D06M 2101/16; D06M 2200/30

(57) ABSTRACT

Flame retardant co-formulation in a form of an aqueous dispersion including a brominated phosphate ester and a melamine resin. A process for preparing the co-formulation, a method of reducing the flammability of a cellulose-based textile by treating the textile with the co-formulation, and a flame retarded cellulose-based textile product are also provided.

### CROSS-REFERENCE TO RELATED APPLICATIONS

This application is a National Stage application of International Patent Application No. PCT/IL2023/051109, filed on Oct. 26, 2023, which claims priority to U.S. Provisional Patent Application No. 63/419,742, filed on Oct. 27, 2022, each of which is hereby incorporated by reference in its entirety.

### TECHNICAL FIELD

The present invention relates to the field of flame-retardants and, more particularly, to novel flame retardant systems for cellulose-based textiles, their preparation and to cellulose-based textiles that are flame retarded with these systems.

### BACKGROUND

Textile flame retardance treatment strategies are divided into (i) inherent treatments, where the flame retardant (FR) component is integrated in the polymer chain during polymerization; and (ii) finishing approaches where the flame retardant is added to the already formed fiber. Finishing approaches are further divided into (a) reactive, where the flame retardant reacts with the fiber polymer, and (b) additive, where the flame retardant is adhered to the fiber surface using a polymeric adhesive/binder. Additive flame retardants of low molecular weight may migrate from the fiber during use, whereas polymeric flame retardants resist migration better.

Reactive flame retardants must be suited for the target substrate. Two main reactive phosphorus-based flame retardant (PFR) processes are currently used in cellulose-based, for example cotton-based, textiles. These are the Pyrovatex® CP (N-methylol Dimethyl phosphonpropionamide) pad/cure process and THPC based Proban® with an ammonia gas cure system.

The main drawbacks of the existing reactive phosphorus-based flame retardants (PFRs) include hydrolysis of Pyrovatex during storage and emission of noxious formaldehyde and its derivatives, the need for a dedicated, potentially hazardous, gaseous ammonia cure chamber for Proban, weakening of the cotton over time (often termed tendering) due to slow evolution of phosphoric acid and long washing off processes after application.

No reactive bromine-containing flame retardant (BFR) systems exist for cellulose-based textiles, such as cotton and cotton-rich blend textiles. All currently known textile BFRs are additive. Primarily, because of the challenges associated with achieving effective reaction of a BFR with a cellulose fiber; let alone at sufficient load of the BFR to the cellulose-based fabric, i.e., in an amount effective to reduce flammability.

Concerns regarding migration of additive BFRs can be addressed if the BFR is reactive, that is chemically/physically bound to the cellulose-based textile substrate, i.e., by covalent bonding to or physical entanglement with a cellulose fiber. Reactive BFRs also have the potential to be more efficient than PFRs in applications where gas phase active flame retardants have an advantage.

### SUMMARY

The present invention discloses bromine-containing flame retardant (BFR)-based compositions, their preparation, and their use as flame-retardants in cellulose-based textile applications, in particular for textile applications requiring washing durability. Without being bound to any specific theory, it is thought that the bromine-containing flame retardant (BFR)-based composition of the invention is chemically/physically incorporated into the textile. Incorporation of the BFR composition into the cellulose-based textile, was verified by testing the treated fabric and the reaction medium and demonstrating that there was no presence of the starting reactants, indicating full conversion of the starting chemicals. Fixation of the BFR composition to the fabric, was further confirmed by subjecting the fabric to repeated laundering and testing for flammability. Unbound BFR would wash off after several laundry cycles whereas fabrics treated with the compositions of the invention withstood over 100 laundry cycles with no degradation of flammability resistance. Hence, the present invention further discloses cellulose-based textiles (e.g., fabrics) that comprise the bromine-containing flame retardant (BFR)-based composition of the invention bound on and/or incorporated into the textile.

The invention provides in a first aspect an aqueous flame retardant composition (dispersion) comprising a brominated phosphate ester flame retardant (BPFR) and a linking agent.

The aqueous flame retardant composition (dispersion) may further include customary additives, such as for example one or more of dispersants, wetting agents, surfactants, softeners.

The aqueous flame retardant compositions of the present invention were found to be suitable for textile applications on a variety of cellulose-based fabrics, maintaining high efficiency after many washing cycles. Accordingly, another aspect of the invention is a cellulose-based textile product (e.g., fabric) treated with an aqueous flame retardant composition of the invention. Another aspect of the invention is a cellulose-based textile product (e.g., fabric) that includes an aqueous flame retardant composition of the invention bound on and/or incorporated into the textile. In yet another aspect, the invention provides a flame retarded cellulose-based textile product that comprises a cellulose-based textile (e.g., fabric), a brominated phosphate ester flame retardant (BPFR) and a linking agent.

As pointed out above, the aqueous flame retardant compositions (dispersions) of the invention comprise a brominated phosphate ester flame retardant (BPFR), for example, trialkyl phosphate, where the alkyl is brominated. The bromine content of the brominated phosphate ester flame retardant (BPFR) that forms part of the formulations of the invention is not less than 55%, e.g., >65%, ˜70% by weight of the molecule.

In contrast, and as exemplified in comparative examples (Example 2), when the inventors prepared the corresponding flame retardant systems based on other flame retardant compounds, including other brominated organophosphorus compounds, and applied them on cellulose-based textiles, such as fabrics comprising 50-100% cotton, they all failed the flame retardancy tests, some even before laundry.

Different types of brominated phosphate ester flame retardants (BPFRs) can be used in the aqueous dispersions of the invention.

For example, we have found that one type of brominated phosphate esters that is well suited for use in the formulations of the invention is represented by Formula I.

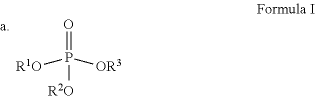

wherein each of R¹, R² and R³ is independently selected from a brominated alkyl group.

The brominated alkyl group in the compounds of Formula I is preferably an alkyl group, such as methyl, ethyl, n-propyl, iso-propyl, butyl, iso-butyl, sec-butyl, tert-butyl, n-pentyl, iso-pentyl, neo-pentyl, tert-pentyl, n-hexyl, iso-hexyl, and the like.

The brominated phosphate ester of Formula I may be synthesized as known in the art. For example, by reacting three moles of a brominated alkyl alcohol with one mole of a phosphorus oxyhalide under conditions well known in the art (see, for example, U.S. Pat. No. 5,710,309 and the references cited therein).

Preferably, the bromine content of the brominated phosphate ester is not less than 55% by weight of the molecule. Especially preferred brominated phosphate esters of Formula I that are well suited to the formulations of the invention have a bromine content of not less than 65% by weight of the molecule.

Preferably, at least two of R¹, R² and R³ in the brominated phosphate esters of Formula I are substituted with bromine, i.e. brominated. More preferably, all of R¹, R² and R³ in the brominated phosphate esters of Formula I are substituted with bromine. Preferably, each of R¹, R² and R³ in the brominated phosphate esters of Formula I is substituted with a bromine atom. More preferably, each of R¹, R² and R³ in the brominated phosphate esters of Formula I is substituted with multiple, i.e. two or more, bromine atoms, i.e. polybrominated.

Suitable commercially available brominated phosphate esters (BPFRs) of Formula I include tris(tribromoneopentyl)phosphate:

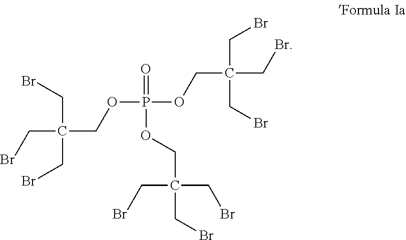 [SMILES: O=P(OCC(CBr)(CBr)CBr)(OCC(CBr)(CBr)CBr)OCC(CBr)(CBr)CBr]

Preferably, the BPFR of Formula I is tris(tribromoneopentyl) phosphate available as TexFRon® 3000 (FR-370) from ICL, Israel.

As pointed out above, the aqueous flame retardant composition (dispersion) of the invention comprises a linking agent. Different types of linking agent can be used in the aqueous compositions of the invention. Suitable linking agents are either capable of forming a chemical bond (e.g., covalent bond) with the flame retardant in the composition, and with the cellulose polymer, upon application of the formulation to the cellulose-based textile product (e.g., fabric); or are resins, such as branched resins, that incorporate the flame retardant and bind it through covalent bonding and/or physical entanglement of the resin network with the cellulose fibers/polymer. Preferably, the linking agent is a branched melamine resin having a molecular weight above 150 gr/mole. Without being bound to any specific theory, it is thought that the linking agent interacts with the brominated phosphate ester flame retardant (BPFR) to create a continuous, branched complex resin network that firmly binds to the cellulose fibers/polymer.

Typically, such linking agents are suited for application of the composition of the invention to the cellulose-based textile product under conditions that do not degrade the cellulose fiber. Suitable linking agents allow sufficient amounts of the flame retardant to be bound to the cellulose fiber under such conditions, to obtain cellulose-based textile product having adequate resistance to fire.

In contrast, and as exemplified in Example 4, when the inventors prepared the corresponding flame retardant co-formulations with lower molecular weight linking agents, having a molecular weight of or below 150 gr/mole, and applied the resulting co-formulations on fabrics, such as 100% cotton, the bonding of co-formulations to the fabric was insufficient to effectively reduce fabric flammability (see Tables 19-21). Without being bound to any specific theory, it is thought that the unsuccessful linking agents interact with the BPFR to create less interpenetrating resin networks that more loosely bind to the cellulose fibers/polymer.

Representative examples of suitable linking agents include melamine resins having a molecular weight above 150 gr/mole, above 180, above 300, above 400, above 500, above 600, above 700 gr/mole. Some suitable linking agents include melamine resins having a molecular weight of about 500 gr/mole, having a molecular weight above 500 gr/mole. Preferred linking agents suitable for the compositions of the present invention are methylol-based melamine resins and melamine-formaldehyde resins. These are especially desirable because they are rich in nitrogen which contributes to overall flame retardancy. Especially preferred organic linking agents suitable for the compositions of the present invention are partially methylated melamine formaldehyde resins, methylated melamine formaldehyde resin and methylated high imino melamine resins having a molecular weight above 150 gr/mole, above 180, above 300, above 400, above 500, above 600, above 700 gr/mole. Suitable commercially available linking agents include alkyl modified melamine derivates such as Madurit® MW830, Saduren®, Maprenal®, Resimene®, Leaf, Cymel® 385. Preferably, the linking agent is a melamine derivate, such as partially methylated melamine formaldehyde resin, methylated melamine formaldehyde resin and methylated high imino melamine resin, e.g., Astro Mel™ NW3A available from Hexion Specialty Chemicals Inc, Cymel® 385 available from Allnex GmbH, Madurit® MW 830 75% WA available from Prefere Resins Holding GmbH.

Accordingly, preferred flame retardant aqueous dispersions of the invention comprise:
a) a brominated phosphate ester of Formula I:

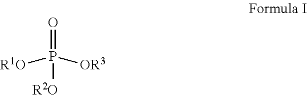

wherein each of R¹, R² and R³ is independently selected from a brominated alkyl group; and
b) a melamine resin having a molecular weight above 150 gr/mole, above 180, above 300, above 400, above 500, above 600, above 700 gr/mole, preferably having a molecular weight of about 500 gr/mole, having a molecular weight above 500 gr/mole.

Preferably, the bromine content of the brominated phosphate ester of Formula I is not less than 55% by weight of the molecule, preferably exceeding 60% or even 65% by weight of the molecule.

Especially, preferred flame retardant aqueous dispersions of the invention comprise:
(a) a brominated phosphate ester of Formula I:

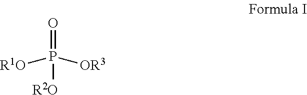

wherein each of R¹, R² and R³ is independently selected from a brominated alkyl group;
preferably the alkyl group is independently selected from methyl, ethyl, n-propyl, iso-propyl, butyl, iso-butyl, sec-butyl, tert-butyl, n-pentyl, iso-pentyl, neo-pentyl, tert-pentyl, n-hexyl, and iso-hexyl; preferably, each of R¹, R² and R³ is independently substituted with two or more, bromine atoms and
b) a melamine resin selected from partially methylated melamine formaldehyde resin, methylated melamine formaldehyde resin, and methylated high imino melamine resin, having a molecular weight above 150 gr/mole, above 180, above 300, above 400, above 500, above 600, above 700 gr/mole, preferably having a molecular weight of about 500 gr/mole, having a molecular weight above 500 gr/mole.

In some embodiments the flame retardant aqueous dispersions of the invention comprise:
(a) a brominated phosphate ester of Formula Ia:

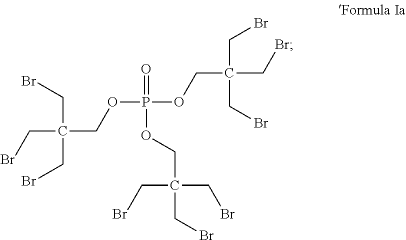 [SMILES: O=P(OCC(CBr)(CBr)CBr)(OCC(CBr)(CBr)CBr)OCC(CBr)(CBr)CBr]

and
b) a melamine resin selected from partially methylated melamine formaldehyde resin, methylated melamine formaldehyde resin, and methylated high imino melamine resin, having a molecular weight above 150 gr/mole, above 180, above 300, above 400, above 500, above 600, above 700 gr/mole, preferably having a molecular weight of about 500 gr/mole, having a molecular weight above 500 gr/mole.

The aqueous flame retardant compositions (dispersions) of the present invention are typically prepared via a two-step process. In the first step, two individual preparations are prepared. The brominated phosphate ester (BPFR) is dispersed in water/aqueous medium (see for example Table 5, Examples, Preparation 10). The linking agent is separately dispersed in water/aqueous medium (see for example Table 6, Examples, Preparations 11-15). In the second step, the brominated phosphate ester (BPFR) dispersion and the linking agent dispersion are combined to form a homogeneous, stable aqueous composition (see for example Table 8, Examples). The so prepared aqueous flame retardant compositions (dispersions) of the present invention are stable, showing no phase separation or settling of solids during storage, at least for 60 days.

To prepare the individual dispersion of the brominated phosphate ester (BPFR), the BPFR is added to a vessel that was previously charged with a mixed solution of deionized water, dispersing agent and wetting agent. Incorporation of the BPFR into the aqueous mixture can be achieved with the aid of a dissolver stirrer/disperser operating at 100 to 300 rpm on a laboratory scale. The mixture is typically allowed to disperse for 10 to 60 minutes on a laboratory scale. A stable aqueous preparation of the brominated phosphate ester (BPFR) is formed. The content of the brominated phosphate ester is typically not less than 35%, e.g., from 35% to 40% by weight based on the total weight of the individual BPFR preparation (dispersion).

Suitable grades of brominated phosphate esters consist of micron or sub-micron particles (for example, with a particle size distribution of d₅₀≤5 μm (e.g., d₅₀≤4 μm, more preferably d₅₀≤3 μm) and d₉₀≤15 μm (e.g., d₉₀≤10 μm, more preferably d₉₀≤6 μm), measured by laser diffraction. Such suitable grades may be obtained by methods know in the art, such as for example dry milling (JET MILL) of the BPFR.

To prepare the individual dispersion of the linking agent, the linking agent is added to a vessel that was previously charged with a solution of a surfactant, optionally softener, and optionally deionized water. Since a sufficient amount of water is present in the surfactant commercial product, further addition of water is typically not required. Incorporation of the linking agent into the aqueous mixed solution can be achieved with the aid of a dissolver stirrer/disperser operating at 100 to 300 rpm on a laboratory scale. The mixture is typically allowed to disperse for 10 to 60 minutes on a laboratory scale. A stable aqueous dispersion of the linking agent is formed. The content of the linking agent is typically not less than 49%, e.g., from 49% to 63% by weight based on the total weight of the aqueous individual linking agent preparation (dispersion).

Next, the brominated phosphate ester (BPFR) dispersion and the linking agent dispersion are combined to give a co-formulation, i.e., in a dispersion form, also referred to herein as an aqueous flame retardant composition of the invention. The content of the BPFR, i.e. compound of Formula I, in the co-formulation is generally in the range of about 15% to about 25% by weight, preferably in the range of about 19% to about 22% by weight, based on the total weight of the co-formulation. The content of the linker, i.e. melamine resin, in the co-formulation is generally in the range of about 15% to about 30% by weight, preferably in the range of 19-28% by weight based on the total weight of the co-formulation. The weight percent values as specified herein refer to the dry weights of the BPFR and the linker.

The order of addition of the individual dispersions to a vessel to create a co-formulation of the BPFR and the linking agent is not critical. One possible order of addition is to charge a vessel with the linking agent dispersion, followed by addition of the brominated phosphate ester dispersion, under homogenization using a dissolver stirrer. The order of the addition of the BPFR dispersion and the linker dispersion can be reversed.

Separate preparation of the BPFR dispersion and the linker dispersion prior to combining the BPFR and the linker to give a co-formulation is required to achieve a stable co-dispersion.

The aqueous flame retardant composition (dispersion) of the invention (i.e. the co-formulation of the BPFR and the linking agent) comprises customary additives, such as for example one or more of dispersants, wetting agents, surfactants, softeners. Such customary additives are usually present in the formulation in an amount from 1 to 14% by weight each, e.g. from 1-7% by weight each.

The weight percent values as specified herein refer to the dry weight of the active agent present in the additive formulated product. The term “wet weight” as specified herein refers to the weight of the additive formulated product that includes the active agent, water/aqueous medium and optionally other components that form part of such formulations.

An aqueous flame retardant composition comprising a brominated phosphate ester and a linking agent dispersed in water/aqueous medium in the presence of one or more of dispersing agent, wetting agent, surfactant, and softener, with BPFR and linker at the amounts set out above, forms a specific aspect of the invention.

The aqueous flame retardant composition of the invention may further comprise one or more of additional types of additives such as, for example rheology modifiers, i.e., thickeners and anti-settling agents, usually from 0.5 to 1% by weight of the total composition.

Preferably, one or several of surfactant, dispersing agent, wetting agent, dispersing agent possessing the necessary wetting properties, and softener are present in each of the individual BPFR and linker preparations. Typically, such additives are present at a concentration from 1 to 14% by weight each, based on the total weight of the individual preparation. Suitable surfactants, dispersing agents, wetting agents, and softeners are known in the field of textile flame retardation and can be easily determined by a person skilled in the art.

For example, the dispersant may be a nonionic dispersing agent, such as nonionic acrylate copolymer (e.g., DYSPERBYK®—2010, available in an emulsion form, possessing also wetting function); or a ionic dispersing agent, such as the alkali, alkaline earth, and ammonium salts of aromatic sulfonic acids, for example, alkyl-substituted aromatic sulfonic acids (for example, alkyl-substituted benzene and naphthalene sulfonic acids, e.g., the sodium salt of di-isopropyl or di-butyl naphthalene sulfonic acid, available as SUPRAGIL® WP). Suitable dispersants include acrylate copolymer surfactants such as 2-acrylamide-2-methyl-1-propanesulfonic acid and alkyl methacrylamide, alkyl methacrylate or alkyl acrylate, poly(allylamine)-supported phases, poly(ethyleneimine). Commercially available dispersing agents include Disperbyk® 2010, EDPLAN 490/492, Agrilan® 788, Carbopol® Aqua SF-1. Preferably, the dispersing agent is Disperbyk® 2010.

Various surfactants such as anionic, cationic, non-ionic or amphoteric surfactants may be employed. For example, suitable commercially available surfactants include anionic surfactants, such as derivatives of isotridecyl alcohol, e.g. ethoxylated and sulphated isotridecyl alcohols. Commercially available surfactants include Sermul® EA 266, SULFOROKAnol®IT2030, ROKAnol® IT series. Preferably, the surfactant is Sermul® EA 266.

Suitable wetting agents include, for example, alkyl-substituted benzene sulfonic acid and alkyl-substituted naphthalene sulfonic acid derivatives, e.g. sodium di-isopropyl naphthalene sulphonate and sodium di-butyl naphthalene sulphonate. Commercially available wetting agents include Supragil® WP, Morwet® IP, Powercon-100. Preferably, the wetting agent is Supragil® WP.

As pointed out above, the individual preparation of the brominated phosphate ester is preferably in a form of an aqueous dispersion. A stable aqueous dispersion of a brominated phosphate ester (BPFR) can be achieved with the aid of a dispersant and of a wetting agent. Dispersing agents of the polymeric nonionic kind are preferred. Water is preferably present in an amount of 50 to 70% by weight of the BPFR preparation. The brominated phosphate ester is present in an amount effective to provide a cellulose-based textile product treated therewith adequate resistance to fire, preferably in an amount of not less than 35%, e.g., from 35% to 40% by weight based on the total weight BPFR preparation. The dispersing agent and the wetting agent are present in an amount effective to stabilize the BPFR dispersion. Usually the dispersing agent is present in an amount of about 1 to 3% by weight of the BPFR dispersion. Preferably the dispersing agent is present in an amount of 1.5 to 2.5% by weight of the BPFR dispersion. Usually the wetting agent is present in an amount of below 1% by weight of the BPFR dispersion. The wetting agent is preferably present in an amount of 0.15 to 0.25% by weight of the BPFR dispersion.

As pointed out above, the individual preparation of a linking agent is preferably in a form of an aqueous dispersion and can be achieved with the aid of a surfactant. Various surfactants such as anionic, cationic, non-ionic or amphoteric surfactants may be employed. Preferred surfactants include isotridecylalcohol, ethoxylated, sulfated, sodium salt. Water is present in an amount of 15 to 30% by weight, preferably in an amount of 16 to 25% by weight, of the linker preparation. Since a sufficient amount of water is present in the surfactant commercial product, further addition of water is typically not required. The linker is present in an amount effective to bind sufficient amounts of the BPFR to the cellulose fiber, typically in an amount of not less than 49%, usually in an amount of 50 to 65% by weight, preferably in an amount of 60 to 65% by weight, of the linker preparation. The surfactant is present in an amount effective to stabilize the linker dispersion, usually in an amount of 10 to 20% by weight, preferably in an amount of 12 to 18% by weight (dry weight % that does not account for about 50% water that is typically present in the surfactant commercial product), of the individual linker dispersion.

One or more softening agent products (such as ethers and polyglycol esters, ethoxylated products, paraffins, fats, or fatty acid condensates) are optionally added, usually in an amount of 10 to 15% by wet weight, preferably in an amount of 10 to 12% wet weight of the individual linker preparation (corresponding to about 1% dry weight of the active softening agent). The softening agent may be, for example, a commercially available softener selected from Megasoft®, Safflon, Terine OC, Silky SF.

As described before, the brominated phosphate ester (BPFR) preparation and the linking agent preparation are combined in a co-formulation, i.e., in a dispersion form, also referred to herein as an aqueous flame retardant composition of the invention. Preferred aqueous flame retardant compositions (co-formulations) of the invention comprise (percentage by weight based on the total weight of the co-formulation):
from 50 to 70% by weight of water, e.g., 50 to 66%;
from 15 to 30% by weight of brominated phosphate ester of Formula I; e.g., from 19 to 22%;
from 15 to 30% by weight of melamine resin linking agent, e.g., 19 to 28%.

The co-formulation, also referred to herein as an aqueous flame retardant composition of the invention, further contains customary dispersion additives. Major types of additives may include: one or more dispersing agent, usually from 1 to 5% by weight, e.g., from 1 to 2.5% by weight (1 to 1.5%);
one or more wetting agent, usually up to 1% by weight, e.g. from 0.1 to 0.25% by weight (0.1 to 0.15%);
one or more surfactant, usually from 2 to 10% by weight, e.g., 6 to 7%; and optionally
one or more softener, usually from 2 to 7% by weight of, e.g., 3 to 6%.

Especially preferred aqueous flame retardant compositions (co-formulations) of the invention comprise (percentage by weight based on the total weight of the aqueous composition):
from 50 to 70% by weight of water, e.g., 50 to 66%;
from 15 to 30% by weight of compound of Formula I (e.g., tris-(tribromoneopentyl)-phosphate (FR-370), e.g., from 19 to 22%;
from 15 to 30% by weight of alkyl modified melamine resin linking agent having a molecular weight above 150 gr/mole, above 180, above 300, above 400, above 500, above 600, above 700 gr/mole, e.g., having a molecular weight of about 500 gr/mole, having a molecular weight above 500 gr/mole, such as partially methylated melamine formaldehyde resin, methylated melamine formaldehyde resin and methylated high imino melamine resin, e.g., ASTRO™ MEL NW3A, Cymel® 385, Madurit® MW 830 75% WA, e.g., from 19 to 28%;
from 1 to 2.5% by weight of nonionic polymeric dispersing agent, e.g., Disperbyk® 2010, e.g., from 1 to 1.5%;
from 0.1 to 0.25% by weight of wetting agent, e.g., Supragil® WP, e.g., from 0.1 to 0.15%;
from 2 to 10% by weight of surfactant, corresponding to about from 10 to 20% by wet weight of surfactant, e.g. Sermul® EA 266, e.g., from 12 to 14% wet weight; and optionally
from 2 to 7% by weight of softener, e.g. Megasoft® Jet LF, e.g., from 6 to 7%.

Preferred aqueous flame retardant compositions (co-formulations) of the invention comprise from 15% to 25% by weight of the compound of Formula I based on the total weight of the composition; and 15% to 30% by weight of the melamine resin based on the total weight of the composition.

The aqueous flame retardant compositions (co-formulations) of the invention were found to be suitable for textile applications, on a variety of cellulose-based products (e.g. fabrics), to obtain a cellulose-based textile product having adequate resistance to fire.

Experimental work conducted in support of this invention demonstrates that cellulose-based textiles treated with the aqueous flame retardant compositions (co-formulations) of the invention maintain adequate resistance to fire (Examples 2-4). Cellulose-based textiles treated with the aqueous flame retardant compositions (co-formulations) of the invention maintain adequate resistance to fire after many washing cycles (Examples 2-4).

The aqueous flame retardant compositions (co-formulations) of the invention are suited for application to a cellulose-based product (e.g., fabric), for obtaining a cellulose-based textile product having adequate resistance to fire. Preferably the cellulose-based textile (e.g., fabric) is “cellulose-rich”, comprising at least 50%, at least 60%, at least 70%, at least 80%, at least 90%, 100%, of cellulose fibers. Accordingly, such cellulose-based textile product (i.e., cellulose-rich textile product) treated with an aqueous flame retardant composition of the invention forms another aspect of the invention.

Suitable cellulose-based textile may comprise natural plant-based fibers such as cotton, hemp, sisal, flax, jute, ramie, bagasse or may be based on man-made cellulosic fiber such as regenerated cellulose, viscose, rayon, cupro, lyocell, modal, or a mixture thereof. Preferably, the cellulose natural plant-based fiber in the cellulose-based textile or in a cellulose/synthetic fiber blend is cotton.

Preferably the cellulose-based textile product is cellulose-rich, i.e. comprises at least 50%, at least 60%, at least 70%, at least 80%, at least 90%, 100%, of cellulose fibers. Such cellulose-rich textiles may comprise both cellulose and synthetic fibers. “Synthetic fibers” means that the fibers are man-made fibers produced entirely from chemical substances. The synthetic fibers in cellulose-containing textile materials (cellulose/synthetic fiber blends) that are treated by the aqueous flame retardant composition (co-formulation) of the invention can for example be polyethylene terephthalate (PET), polybutylene terephthalate (PBT), polylactic acid (PLA), polyolefins, polyamides (Nylon), polyurethane (Lycra) and polyacrylonitrile (Acrylic). Preferably, the synthetic fiber in the cellulose-containing textile material is polyethylene terephthalate (PET), herein it is also named “polyester”. Preferably, the synthetic fiber in the cellulose-containing textile material, i.e. cellulose/synthetic fiber blend, is selected from polyethylene terephthalate (polyester), polyamide (Nylon), polyurethane (Lycra) and polyacrylonitrile (Acrylic).

The aqueous flame retardant compositions (co-formulations) of the invention are added to the cellulose-rich textile in an amount effective to reduce flammability, also identified herein as “add-on” level. The “add-on” level refers to the total amount of the composition (including reactive compounds and non-active additives) loaded onto the treated cellulose-based textile. The “add-on” level is calculated based on the difference between the weight of the dry textile, e.g., fabric, before and after the treatment with the aqueous flame retardant composition (co-formulation) of the invention. Adequate resistance to fire, fulfilling the criteria of acceptable flammability tests described in the experimental section below, is achieved with the aid of the aqueous flame retardant composition (co-formulation) at “add-on” levels of 30 to 40% by cellulose-based textile, e.g., fabric, weight.

Accordingly, another aspect of the invention is a flame retarded cellulose-based textile product comprising:
a) cellulose-based textile, e.g., fabric;
b) a brominated phosphate ester of Formula I:

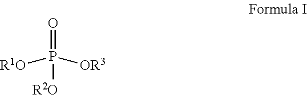

wherein each of R¹, R² and R³ is independently selected from brominated alkyl group; and c) a melamine resin having a molecular weight above 150 gr/mole, above 180, above 300, above 400, above 500, above 600, above 700 gr/mole, preferably having a molecular weight of about 500 gr/mole, having a molecular weight above 500 gr/mole.

Preferably, the flame retarded cellulose-based textile product of the invention comprises the brominated phosphate ester of Formula I and the melamine resin bound on the textile product, incorporated into the textile product or reacted with the textile product.

A specific flame retarded cellulose-based textile product comprises:
a) cellulose-based textile, e.g., fabric;b) a brominated phosphate ester of Formula I:

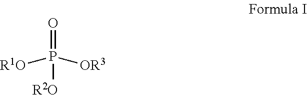

wherein each of R¹, R² and R³ is independently selected from brominated alkyl group; and
c) a melamine resin having a molecular weight above 150 gr/mole, above 180, above 300, above 400, above 500, above 600, above 700 gr/mole, preferably having a molecular weight of about or above 500 gr/mole,
wherein the brominated phosphate ester of Formula I and the melamine resin are bound on the textile product, incorporated into the textile product or reacted with the textile product.

Another aspect of the invention is a method of imparting flame retardancy to a cellulose-based textile comprising treating the cellulose-based textile with a flame retardant aqueous composition that comprises:
a) a brominated phosphate ester of Formula I:

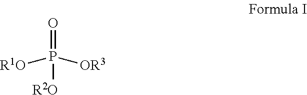

wherein each of R¹, R² and R³ is independently selected from brominated alkyl group; and
b) a melamine resin having a molecular weight above 150 gr/mole, above 180, above 300, above 400, above 500, above 600, above 700 gr/mole, preferably having a molecular weight of about 500 gr/mole, having a molecular weight above 500 gr/mole.

The amount of the brominated phosphate ester of Formula I bound on and/or incorporated into the cellulose-based textile product is 5 to 20% by weight, preferably 9 to 16% by weight, of the textile product e.g., fabric. The amount of the melamine resin bound on and/or incorporated into the cellulose-based textile product is 10 to 20% by weight, preferably 14 to 20% by weight, of the textile product e.g., fabric.

According to another aspect, the present invention provides a process of applying the aqueous flame retardant composition (co-formulation) of the invention to a cellulose-based textile (i.e., cellulose-rich textile) product, the process comprising:
(i) contacting the cellulose-based textile product, such as fabric, with the aqueous flame retardant composition of the invention; and
(ii) heating the cellulose-based textile product.

Contacting of the cellulose-based textile, e.g. fabric, with the aqueous flame retardant composition of the invention can be achieved by common techniques for applying a liquid formulation onto the fabric, such as by coating, spraying and dipping. For example, a cellulose-based fabric is immersed in a suitable tank filled with the aqueous flame retardant composition of the invention, then squeezed between two rollers.

Subsequent to contacting with the aqueous flame retardant composition of the invention, cellulose-based textile, e.g. fabric, is heated for drying and curing.

The drying temperature may be adjusted according to the type of the cellulose-based textile. Typical drying temperature is about 100° C. to 120° C., preferably about 105-110° C., for a drying time period of several minutes, depending on the amount of the treated textile.

Next, the fabric temperature is raised for curing of the flame retardant composition. Typical curing temperature is about 140° C. to 190° C., preferably about 160-185° C., for a curing time period of 30 seconds to several minutes. The curing temperature and time may be adjusted according to one or more of considerations such as the type of the cellulose-based textile, the melting temperature of the BPFR, the curing equipment available and the curing temperature of the linking agent.

Accordingly, a preferred process of the invention for applying the aqueous flame retardant composition (co-formulation) of the invention to a cellulose-based textile (i.e., cellulose-rich textile) product comprises:
(i) contacting the cellulose-based textile product, such as fabric, with the aqueous flame retardant composition of the invention;
(ii) drying the cellulose-based textile product, preferably at a temperature from about 100° C. to 120° C., e.g. at about 105-110° C.; and
(iii) curing the flame retardant composition, preferably at a temperature from about 140° C. to 190° C., e.g. at about 170-185° C.

### BRIEF DESCRIPTION OF THE DRAWINGS

FIG. 1 shows a scanning electron micrograph of untreated cotton fabric, observed under ×500 magnification, using a JEOL JSM 5410 instrument. The specimen was coated with GOLD prior to microscopy.

FIG. 2 shows a scanning electron micrograph of a cotton fabric sample (Example 2, Table 10, Sample #2) that was treated with a flame retardant co-formulation of the invention and laundered 5 times according to AATCC Standard Practice for Home Laundry at 60° C., bone dried and observed under ×500 magnification, using a JEOL JSM 5410 instrument. The specimen was coated with GOLD prior to microscopy.

FIG. 3 shows a scanning electron micrograph of a cotton fabric sample (Example 2, Table 10, Sample #2) that was treated with a flame retardant co-formulation of the invention and laundered 60 times according to AATCC Standard Practice for Home Laundry at 60° C., bone dried and observed under ×500 magnification, using a JEOL JSM 5410 instrument. The specimen was coated with GOLD prior to microscopy.

FIG. 4 shows a photograph of cotton fabric samples (Example 2, Table 11, Samples #5-8) that were treated with a flame retardant co-formulation of the invention, laundered 0-100 times according to AATCC Standard Practice for Home Laundry at 60° C., bone dried and tested according to ASTM D 6413-08 12 seconds ignition test.

### DETAILED DESCRIPTION

### Examples

### Materials

Materials used in the Examples are tabulated in Table 1.

TABLE 1

| MATERIAL | | |
|---|---|---|
| (Further description) | MANUFACTURER | FUNCTION |
| ASTRO ^{™} MEL NW3A | Hexion Inc. | linker |
| (partially methylated melamine | | |
| formaldehyde) | | |
| Cymel ® 303 | Allnex GmbH | linker |
| (highly methylated monomeric | | |
| melamine cross linker) | | |
| Cymel ® NF 2000A | Allnex GmbH | linker |
| (trifunctional melamine base | | |
| crosslinker) | | |
| Cymel ® 385 | Allnex GmbH | linker |
| (methylated high imino | | |
| melamine resin) | | |
| CARBODILITE ^{™} E-02 | Nisshinbo Chemical | linker |
| (polycarbodiimide based | INC | |
| emulsion type crosslinker) | | |
| Madurit ® MW 830 75% WA | Prefere Resins Holding | linker |
| (methylated melamine | GmbH | |
| formaldehyde resin) | | |
| DisperBYK ® 2010 | BYK-Chemie GmbH | dispersion agent |
| (Linear alkyl/tertiary amine poly | | |
| methacrylate block copolymer | | |
| type) | | |
| Megasoft ® Jet LF | Huntsman | softener |
| Sermul ^{™} EA 266 | Elementis | surfactant |
| (an anionic surfactant, based on | | |
| the sodium salt of ethoxylated | | |
| and sulphated isotridecyl | | |
| alcohol) | | |
| Supragil ® WP | Solvay/Rhodia | wetting agent |
| (sodium diisopropylnaphtalene | | |
| sulphonate) | | |
| Fyrol PNX ® (oligomeric ethyl | ICL | flame retardant |
| ethylene phosphate) | | |
| Fyrol ® 6 (Diethyl N,N bis (2- | ICL | flame retardant |
| hydroxyethyl) | | |
| aminomethylphosphonate) | | |
| Fyrolflex ® RDP (Resorcinol | ICL | flame retardant |
| bis(diphenyl phosphate)) | | |
| Tribromophenol (TBP) | ICL | flame retardant |
| FR-513 | ICL | flame retardant |
| (tribromoneopentyl alcohol) | | |
| FR-370 | ICL | flame retardant |
| (tris-(tribromoneopentyl)- | | |
| phosphate (available under the | | |
| trade name TexFRon ® 3000) | | |
| FR-1524 (tetrabromobisphenol | ICL | flame retardant |
| A) | | |
| F3010X [tribromophenol end- | ICL | flame retardant |
| capped poly-(glycidyl- | | |
| tetrabromobisphenol A)] | | |
| FR-564 | Was synthesized as | flame retardant |
| [diethyl-pentabromobenzyl | described in co- | |
| phosphonate] | assigned | |
| | WO 2010/046898 | |
| 2,2-bis(bromomethyl) propane- | Was synthesized as | flame retardant |
| 1,3-diyl tetrahydrogen | described below | |
| bisphosphate | | |
| phosphoric acid | Merck | Adjust pH |
| sodium hydroxide | Merck | Adjust pH |
| sodium bicarbonate | Alfa Aesar | To neutralize and wash off |
| | | excess |
| sodium carbonate | Alfa Aesar | To neutralize and wash off |
| | | excess |
| urea | Merck | To neutralize and wash off |
| | | excess |

### Methods

Flammability tests were performed in accordance with BS 8582 and ASTM 6413 flammability tests.

ASTM D 6413-08 12 seconds ignition test: In this method, samples are cut from the fabric to be tested, and are mounted in a frame that hangs vertically from inside the flame chamber. The sample is exposed to a controlled flame for a specified time period (in this case for 12 seconds, one of the strictest flammability tests), and the “after-flame time” and the “after-glow time” are both recorded. Finally, the sample is torn by the use of weights and the char length is measured. To pass, the average char length of five samples cannot exceed 7 inches (17.8 cm). In addition, none of the individual specimens can have a char length of 10 inches (25.4 cm). The sample is further classified as passing the test if its “after flame time” is less than 5 seconds, and its “after glow time” is less than 150 seconds, so as to render the sample applicable even in the stricter “children's nightwear” flammability standards. In the tables shown below, “after-flame time”, “after-glow time” and char length are abbreviated AFT, AGT, and CHL.

Laundry Durability Testing: Fabric samples treated with formulations described herein were subjected to 5 successive washing cycles in accordance with the washing procedure set forth below, followed by one drying cycle in accordance with commonly used drying procedure, based on the Standard Laboratory Practice for Home Laundering (AATCC technical manual/2001). In all washing cycles, the temperature of the washing water is maintained between 58° C. and 62° C., for automatic washing machines, the washing cycle is set for normal washing cycle, and a synthetic detergent that conforms to Standard Laboratory Practice for Home Laundering (AATCC technical manual/2001) is used.

### Fabric Treatment/Curing:

Neutralization process after curing: The fabric was washed for 60 seconds in water heated to 80° C., followed by further washing for 60 seconds in a solution that is 7.5 g sodium bicarbonate, 1 g sodium carbonate, and 6 g of urea per 1 liter of wash solution, at 80° C. The fabric was then rinsed briefly in fresh water, and the excess water was removed from the fabric by padding, followed by drying at 120° C. for 4-5 minutes.

Padding: is a process that is typically used for applying a formulation on a textile substrate and is defined as a process in which the fabric is first passed through a padder containing the FR formulation, and is then squeezed between heavy rollers to remove any excess formulation.

### Synthesis of 1,3-Propanediol, 2,2-bis(bromomethyl)-, bis(dihydrogen phosphate) (CAS #94030-76-9)

157.2 gr (0.6 mole) of dibromoneopentylglycol and 141.8 gr of phosphoric acid (85%) in 250 ml of xylene were refluxed for 10 hours until all the water was removed. A two-phase system was obtained. The lower phase was recovered and poured into 200 ml of acetonitrile/water (3/1) in which the product (1,3-Propanediol, 2,2-bis(bromomethyl)-, bis(dihydrogen phosphate)) precipitated as white powder (% Br: 37.5; % P: 14.6).

### Preparations 1-10

### Aqueous Dispersions of Flame Retardant (FR) Compounds

Deionized water, dispersing agent and wetting agent were mixed using a dissolver stirrer for 5 minutes.

A flame retardant compound was added to the mixed solution of deionized water, dispersing agent and wetting agent. The mixture was allowed to disperse for fifteen (15) minutes at 300 rpm using a dissolver stirrer (by IKA) until a homogenous mixture was obtained, as observed by formation of an emulsion and absence of sedimentation.

The compositions of thus prepared aqueous dispersions of flame retardant (FR) compounds (Preparations 1-10) are provided in Tables 2 to 5.

Tables 2-4 provide compositions of thus prepared aqueous dispersions of phosphorus-based flame retardants (PFRs), bromine-containing flame retardants (BFRs) and brominated phosphate-containing flame retardants, respectively, that were prepared for comparative purposes.

Table 5 provides compositions of thus prepared aqueous dispersions of brominated phosphate esters represented by Formula I (of the invention).

TABLE 2

| FR | | Deionized | Dispersion | | |
|---|---|---|---|---|---|
| Preparation | Flame retardant | Water | agent (weight, | Wetting agent | FR % by |
| # | (weight, g) | (weight, g) | g) | (weight, g) | weight |
| 1 | Fyrol PNX ® | (127.7) | Disperbyk ® | Supragil ® | about |
| | (70) | | 2010 | WP | 35% |
| | | | (3.8) | (0.38) | |
| 2 | Fyrol ® 6 | (127.7) | Disperbyk ® | Supragil ® | about |
| | (70) | | 2010 | WP | 35% |
| | | | (3.8) | (0.38) | |
| 3 | Fyrolflex ® RDP | (127.7) | Disperbyk ® | Supragil ® | about |
| | (70) | | 2010 | WP | 35% |
| | | | (3.8) | (0.38) | |

TABLE 3

| | Flame retardant | | | | |
|---|---|---|---|---|---|
| FR | [particle size | Deionized | Dispersion | | |
| Preparation | distribution, μm] | Water | agent (weight, | Wetting agent | FR % by |
| # | (weight, g) | (weight, g) | g) | (weight, g) | weight |
| 4 | FR-513 (TRINOL) | (37.5) | Disperbyk ® | Supragil ® | 26% |
| | [d₅₀ < 5 μm | | 2010 | WP | |
| | d₉₀ < 15 μm | | (3) | (1.5) | |
| | d₉₉ < 35 μm] | | | | |
| | (15) | | | | |
| 5 | FR-1524 | (37.5) | Disperbyk ® | Supragil ® | 26% |
| | [d₅₀ < 5 μm | | 2010 | WP | |
| | d₉₀ < 15 μm | | (3) | (1.5) | |
| | d₉₉ < 35 μm] | | | | |
| | (15) | | | | |
| 6 | Tribromophenol | (37.5) | Disperbyk ® | Supragil ® | 26% |
| | (TBP) | | 2010 | WP | |
| | [d₅₀ < 5 μm | | (3) | (1.5) | |
| | d₉₀ < 15 μm | | | | |
| | d₉₉ < 35 μm] | | | | |
| | (15) | | | | |
| 7 | FR-3010X | (37.5) | Disperbyk ® | Supragil ® | 26% |
| | [d₅₀ < 5 μm | | 2010 | WP | |
| | d₉₀ < 15 μm | | (3) | (1.5) | |
| | d₉₉ < 35 μm] | | | | |
| | (15) | | | | |

TABLE 4

| | Flame retardant | | | | |
|---|---|---|---|---|---|
| FR | [particle size | Deionized | Dispersion | | |
| Preparation | distribution, μm] | Water | agent (weight, | Wetting agent | FR % by |
| # | (weight, g) | (weight, g) | g) | (weight, g) | weight |
| 8 | FR-564 | (127.7) | Disperbyk ® | Supragil ® | 35% |
| | [d₅₀ < 5 μm | | 2010 | WP | |
| | d₉₀ < 15 μm | | (3.8) | (0.38) | |
| | d₉₉ < 35 μm] | | | | |
| | (70) | | | | |
| 9 | 2,2- | (127.7) | Disperbyk ® | Supragil ® | 35% |
| | bis(bromomethyl)p | | 2010 | WP | |
| | ropane-1,3-diyl | | (3.8) | (0.38) | |
| | tetrahydrogen | | | | |
| | bisphosphate | | | | |
| | [d₅₀ < 5 μm | | | | |
| | d₉₀ < 15 μm | | | | |
| | d₉₉ < 35 μm] | | | | |
| | (70) | | | | |

TABLE 5

| | Flame retardant | | | | |
|---|---|---|---|---|---|
| FR | [particle size | Deionized | Dispersion | | |
| Preparation | distribution, μm] | Water | agent (weight, | Wetting agent | FR % by |
| # | (weight, g) | (weight, g) | g) | (weight, g) | weight |
| 10 | TexFRon ® 3000 | (127.7) | Disperbyk ® | Supragil ® | about |
| | (FR-370) | | 2010 | WP | 35% |
| | [d₅₀ < 5 μm | | (3.8) | (0.38) | |
| | d₉₀ < 15 μm | | | | |
| | d₉₉ < 35 μm] | | | | |
| | (70) | | | | |

### Preparations 11-20

### Aqueous Dispersions of Linking Agent

Deionized water and surfactant (and optionally softener), were mixed using a dissolver stirrer for 5 minutes. Melamine resin was added to the mixed solution of deionized water and surfactant (and optionally softener).

The mixture was allowed to disperse for fifteen (15) minutes using a dissolver stirrer (by IKA) until a homogenous mixture was obtained, as observed by formation of an emulsion and absence of sedimentation.

The compositions of thus prepared dispersions of melamine resin (Preparations 11-20) are provided in Table 6.

TABLE 6

| | | Added | | | |
|---|---|---|---|---|---|
| | | Deionized | | | melamine |
| linker- | melamine resin | Water | Surfactant | Softener | resin % |
| Preparation # | (weight, g) | (weight, g) | (weight, g) | (weight, g) | by weight |
| 11 | ASTRO ™ | (37.5) | Sermul ™ | None | 12% |
| | MEL NW3A | | EA 266 | | |
| | (6) | | (6) | | |
| 12 | ASTRO ™ | None | Sermul ™ | Megasoft ® | 49% |
| | MEL NW3A | | EA 266 | Jet LF | |
| | (60) | | (43.5) | (18) | |
| 13 | ASTRO ™ | None | Sermul ™ | Megasoft ® | 53% |
| | MEL NW3A | | EA 266 | Jet LF | |
| | (70) | | (43.5) | (18) | |
| 14 | ASTRO ™ | None | Sermul ™ | Megasoft ® | 56% |
| | MEL NW3A | | EA 266 | Jet LF | |
| | (80) | | (43.5) | (18) | |
| 15 | ASTRO ™ | None | Sermul ™ | Megasoft ® | 62% |
| | MEL NW3A | | EA 266 | Jet LF | |
| | (100) | | (43.5) | (18) | |
| 16 | Cymel ® 303 | None | Sermul ™ | None | 69.7% |
| | (100) | | EA 266 | | |
| | | | (43.5) | | |
| 17 | Cymel ® NE | None | Sermul ™ | None | 69.7% |
| | 2000A (100) | | EA 266 | | |
| | | | (43.5) | | |
| 18 | Cymel ® 385 | None | Sermul ™ | None | 69.7% |
| | (100) | | EA 266 | | |
| | | | (43.5) | | |
| 19 | CARBODILITE ™ | None | Sermul ™ | None | 69.7% |
| | E-02 (100) | | EA 266 | | |
| | | | (43.5) | | |
| 20 | Madurit ® | None | Sermul ™ | None | 69.7% |
| | MW 830 75% | | EA 266 | | |
| | WA (100) | | (43.5) | | |

### Example 1

### Preparation of Flame Retardant (FR) Co-Formulations

### (Co-Formulations 1-9 and 14-16, Comparative and Co-Formulations 10-13 and 17-18, of the Invention)

A flame retardant dispersion (Preparations 1-10) was added to a linker dispersion (Preparations 11-20). The amounts of each of the individual dispersions are provided in Tables 7 and 8.

The resultant mixture was allowed to mix for fifteen (15) minutes at room temperature at 100-600 rpm using a dissolver stirrer (by Ika). Then the pH of the mixture was adjusted to between 4.5 to 4.6, using aqueous phosphoric acid or sodium hydroxide solutions.

The compositions of thus prepared flame retardant (FR) co-formulations are provided in Table 7 (co-formulations 1-9 and 14-16, all comparative) and Table 8 (co-formulations 10-13 and 17-18, of the invention).

TABLE 7

| Co-for- | | linking agent | | FR:linker |
|---|---|---|---|---|
| mulation | FR preparation | preparation | FR amount | (weight |
| # (name) | (weight, g) | (weight, g) | (weight, g) | ratio, g) |
| 1 | Preparation 1 | Preparation 14 | 65.9 | 65.88 g:80 g |
| (“Fyrol | (190) | (141) | | |
| PNX”) | | | | |
| 2 | Preparation 2 | Preparation 14 | 65.9 | 65.88 g:80 g |
| (“Fyrol | (190) | (141) | | |
| 6”) | | | | |
| 3 | Preparation 3 | Preparation 14 | 65.9 | 65.88 g:80 g |
| (“Fyrolflex | (190) | (141) | | |
| RDP”) | | | | |
| 4 | Preparation 4 | Preparation 11 | 15 | 2 g:1 g |
| (“trinol”) | (57) | (49) | | |
| 5 | Preparation 5 | Preparation 11 | 15 | 15 g:6 g |
| (“FR-1524) | (57) | (49) | | |
| 6 | Preparation 6 | Preparation 11 | 15 | 15 g:6 g |
| (“TBP”) | (57) | (49) | | |
| 7 | Preparation 7 | Preparation 11 | 15 | 15 g:6 g |
| (“FR-3010X”) | (57) | (49) | | |
| 8 | Preparation 8 | Preparation 15 | 65.9 | 65.9 g:100 g |
| (“FR-564) | (190) | (161) | | |
| 9 | Preparation 9 | Preparation 15 | 65.9 | 65.9 g:100 g |
| (“2,2-bis | (190) | (161) | | |
| (bromo | | | | |
| methyl) | | | | |
| propane-1,3- | | | | |
| diyl tetra | | | | |
| hydrogen | | | | |
| bisphosphate”) | | | | |
| 14 | Preparation 10 | Preparation 16 | 65.9 | 65.9 g:100 g |
| (“FR 370 + | (190) | (143.5) | | |
| cymel 303”) | | | | |
| 15 | Preparation 10 | Preparation 17 | 65.9 | 65.9 g:100 g |
| (“FR 370 + | (190) | (143.5) | | |
| cymel | | | | |
| 2000X”) | | | | |
| 16 | Preparation 10 | Preparation 19 | 65.9 | 65.9 g:100 g |
| (“FR 370 + | (190) | (143.5) | | |
| CARBODILITE | | | | |
| E-02X”) | | | | |

TABLE 8

| Co-for- | | linking agent | | FR:linker |
|---|---|---|---|---|
| mulation | FR preparation | preparation | FR amount | (weight |
| # (name) | (weight, g) | (weight, g) | (weight, g) | ratio, g) |
| 10 | Preparation 10 | Preparation 12 | 65.9 | (65.88 g:60 g) |
| (“FR- | (190) | (121) | | |
| 370_60”) | | | | |
| 11 | Preparation 10 | Preparation 13 | 65.9 | (65.88 g:70 g) |
| (“FR- | (190) | (131) | | |
| 370_70”) | | | | |
| 12 | Preparation 10 | Preparation 14 | 65.9 | (65.88 g:80 g) |
| (“FR- | (190) | (141) | | |
| 370_80”) | | | | |
| 13 | Preparation 10 | Preparation 15 | 65.9 | (65.88 g:100 g) |
| (“FR- | (190) | (161) | | |
| 370_100”) | | | | |
| 17 | Preparation 10 | Preparation 18 | 65.9 | (65.88 g:80 g) |
| (“FR 370 + | (190) | (143.5) | | |
| cymel 385”) | | | | |
| 18 | Preparation 10 | Preparation 20 | 65.9 | (65.88 g:100 g) |
| (“FR 370 + | (190) | (143.5) | | |
| Madurit | | | | |
| MW 830 75% | | | | |
| WA”) | | | | |

### Example 2

### Application of FR Co-Formulations to 100% Cotton Knit Fabric

### [Co-Formulations 1-9, (Comparative), and Co-Formulations 10-13, (of the Invention)]

100% cotton knit fabric specimen weighing 200 grams per square meter (grams/m²) was treated by padding it with a flame retardant formulation in a Rapid lab padder (PAD MANGLE by RAPID), as described in the methods above.

The target add-on value of co-formulation was 32% by fabric weight for co-formulations 1-9 (comparative), with acceptable add-on values between 34% and 40% by fabric weight. The target add-on value was 32% by weight for co-formulations 10-13 (of the invention), with acceptable add-on between 30% and 34% by weight.

Thereafter, the fabric specimens were dried at 110° C. for 4-5 minutes, followed by curing at 170-185° C. for a further 7 minutes.

The fabric specimens were neutralized as described in the methods above.

The fabrics were laundered 5-100 times according to AATCC Standard Practice for Home Laundry at 60° C., bone dried and tested according to ASTM D 6413-08 12 seconds ignition test.

Table 9 provides an overview of the test results that were obtained with co-formulations 1-9 (comparative) and co-formulations 10-13 (of the invention) using 100% cotton knit fabric specimens.

TABLE 9

| Co-for- | Add-on values | ASTM D 6413-08 | |
|---|---|---|---|
| mulation | (% by fabric | 12 seconds | |
| # (name) | weight) | ignition test | Notes |
| 1 | %19-20 | Fail before | We were not able to increase |
| (“Fyrol | | laundry | the loading even at higher % |
| PNX”) | | | of dispersion |
| 2 | Not tested | Not tested | The fabric was weakened and |
| (“Fyrol | | | browned after treatment |
| 6”) | | | |
| 3 | %19-20 | Fail before | We were not able to increase |
| (“Fyrolflex | | laundry | the loading even at higher % |
| RDP”) | | | of dispersion |
| 4 | ~9% | Fail before | Fabrics failed flammability |
| (“trinol”) | | laundry | test even before laundry |
| 5 | Not tested | Not tested | There was no reaction at all |
| (“FR- | | | with cotton and therefore, no |
| 1524) | | | flame retardant properties. |
| 6 | Not tested | Not tested | |
| (“TBP”) | | | |
| 7 | Not tested | Not tested | |
| (“FR- | | | |
| 3010X”) | | | |
| 8 | ~35% | Pass before and after | The treated fabrics passed |
| (“FR- | | 10 laundries; | flammability test before and |
| 564”) | | Fail after 15 laundries | after 10 laundries, but failed |
| 9 | ~35% | Pass before and after | after 15 laundry cycles. This |
| (“2,2-bis | | 10 laundries; | is indicative of an unstable |
| (bromo | | Fail after 15 laundries | reaction with the cotton. |
| methyl) | | | |
| propane-1,3- | | | |
| diyl tetra | | | |
| hydrogen | | | |
| bisphosphate”) | | | |
| 10 | ~30-34% | Pass before and after | The fabrics were laundered 5 to |
| (“FR- | | 100 laundries | 100 times. The treated fabrics |
| 370_60”) | | | passed flammability before and |
| 11 | ~30-34% | | after 100 laundries |
| (“FR- | | | |
| 370 70”) | | | |
| 12 | ~30-34% | | |
| (“FR- | | | |
| 370 80”) | | | |
| 13 | ~30-34% | | |
| (“FR- | | | |
| 370 100”) | | | |

Results of the flammability resistance test (ASTM D6413-08 vertical flame test, 12 sec. ignition test) for individual samples of Co-formulation 13 (“FR-370_100”) are provided in Table 10.

TABLE 10

| | | | Cotton 100%(knit) | | |
|---|---|---|---|---|---|
| Co-for- | Sample # | | After | After | Char |
| mulation | (Add-on | Laundry | Flame | Glow | Length |
| # (name) | ~30-34%) | Cycles | sec. | sec. | cm. |
| Co- | 1 | 0 | 0 | 6 | 14.5 |
| Formulation | 2 | 5 | 0 | 3 | 10.5 |
| 13 (FR- | 3 | 10 | 0 | 4 | 13 |
| 370_100”) | 3 | 20 | 0 | 4 | 15 |
| | 2 | 30 | 0 | 4 | 13 |
| | 4 | 40 | 0 | 4 | 14 |
| | 4 | 50 | 0 | 4 | 11 |
| | 2 | 60 | 0 | 3 | 11.5 |
| | 4 | 70 | 0 | 4 | 11.5 |
| | 4 | 100 | 0 | 3 | 14 |

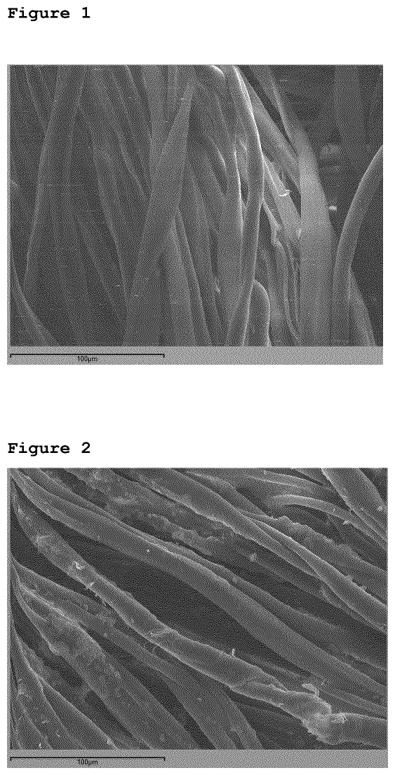

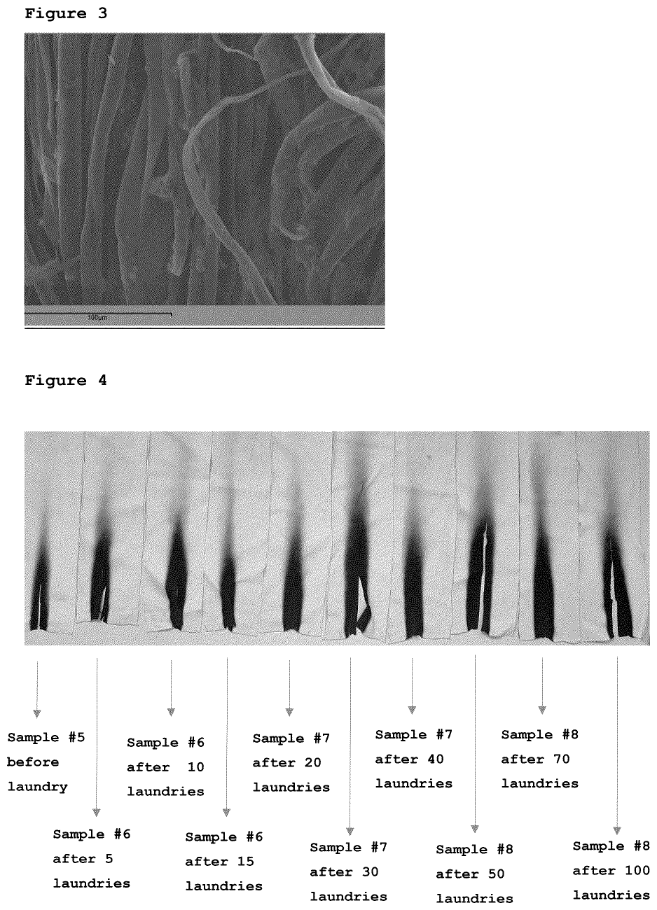

The specimens were also evaluated using electron scanning microscopy SEM. The specimens were observed under ×500 magnification, using a JEOL JSM 5410 instrument. The specimens were coated with GOLD prior to microscopy. The scanning electron micrographs of the untreated cotton fabric, the treated fabric (Table 10, Sample #2), after 5 laundry cycles and after 60 laundry cycles are presented in FIGS. 1-3, respectively.

The micrographs (FIGS. 1-3) show that the reacted BPFR penetrated the fiber matrix. No non fibrous deposits are observed adhered to the cotton fibers.

Results of the flammability resistance test (ASTM D6413-08 vertical flame test, 12 sec. ignition test) for individual samples of Co-formulation 12 (“FR-370_80”) are provided in Table 11.

TABLE 11

| | | | Cotton 100%(knit) | | |
|---|---|---|---|---|---|
| | Sample # | | After | After | Char |
| Formulation | (Add-on | Laundry | Flame | Glow | Length |
| # (name) | ~30-34%) | Cycles | sec. | sec. | cm. |
| Co- | 5 | 0 | 0 | 0 | 10 |
| Formulation | 6 | 5 | 0 | 4 | 11.5 |
| 12 (“FR- | 6 | 10 | 0 | 3 | 9.5 |
| 370 80”) | 6 | 15 | 0 | 3 | 9.5 |
| | 7 | 20 | 0 | 3 | 11 |
| | 7 | 30 | 0 | 3 | 16 |
| | 7 | 40 | 0 | 4 | 12 |
| | 8 | 50 | 0 | 4 | 14 |
| | 8 | 70 | 0 | 3 | 13.5 |
| | 8 | 100 | 0 | 3 | 12 |

A photograph of some of the specimens in Table 11, after the specified number of laundry cycles, and following the flammability test is presented in FIG. 4.

Results of the flammability resistance test (ASTM D6413-08 vertical flame test, 12 sec. ignition test) for individual samples of Co-formulation 11 (“FR-370_70”) are provided in Table 12.

TABLE 12

| | | | Cotton 100%(knit) | | |
|---|---|---|---|---|---|
| Co-for- | Sample # | | After | After | Char |
| mulation | (Add-on | Laundry | Flame | Glow | Length |
| # (name) | ~30-34%) | Cycles | sec. | sec. | cm. |
| Co- | 9 | 0 | 0 | 5 | 12 |
| Formulation | 10 | 5 | 0 | 2 | 13 |
| 11 (“FR- | 10 | 10 | 0 | 3 | 14 |
| 370_70”) | 10 | 15 | 0 | 3 | 16 |
| | 11 | 20 | 0 | 3 | 16 |
| | 11 | 30 | 0 | 4 | 13 |
| | 12 | 40 | 0 | 4 | 16 |
| | 12 | 50 | 0 | 0 | 9 |
| | 12 | 100 | 0 | 2 | 14 |

Results of the flammability resistance test (ASTM D6413-08 vertical flame test, 12 sec. ignition test) for individual samples of Co-formulation 10 (“FR-370_60”) are provided in Table 13.

TABLE 13

| | | | Cotton 100%(knit) | | |
|---|---|---|---|---|---|
| Co-for- | Sample # | | After | After | Char |
| mulation | (Add-on | Laundry | Flame | Glow | Length |
| # (name) | ~30-34%) | Cycles | sec. | sec. | cm. |
| Co- | 13 | 0 | 0 | 6 | 13 |
| Formulation | 14 | 10 | 0 | 3 | 14 |
| 10 (“FR- | 15 | 20 | 0 | 3 | 12.5 |
| 370 60”) | 15 | 30 | 0 | 4 | 16.5 |
| | 16 | 40 | 0 | 1 | 10 |
| | 16 | 50 | 0 | 4 | 15 |
| | 16 | 100 | 0 | 4 | 15.5 |

### Example 3

### Application of Co-Formulations of the Invention to Blended Cotton/Synthetic Fiber Textiles

### 50/50 Cotton/Polyester Woven Fabric

A 50/50 cotton/polyester woven fabric specimen weighing 205 grams per square meter (grams/m²) was treated by padding with Formulation 12 (“FR-370_80”) in a Rapid lab padder (PAD MANGLE by RAPID).

The target add-on value of co-formulation was 40% by fabric weight with acceptable add-on between 30% and 34% by weight.

Thereafter, the fabric specimens were dried at 110° C. for 4-5 minutes, followed by curing at 170-185° C. for a further 7 minutes.

The fabric specimens were neutralized as described in the methods above.

The fabrics were laundered 5 to 100 times according to AATCC Standard Practice for Home Laundry at 60° C., bone dried and tested according to ASTM D 6413-08 vertical flame, 12 seconds ignition test. Results of the flammability resistance test (ASTM D6413-08 vertical flame test, 12 sec. ignition test) for the individual samples are provided in Table 14.

TABLE 14

| | | | 50/50 cotton/polyester (woven) | | |
|---|---|---|---|---|---|
| Co-for- | Sample # | | After | After | Char |
| mulation | (Add-on | Laundry | Flame | Glow | Length |
| # (name) | ~40%) | Cycles | sec. | sec. | cm. |
| Formulation | 17 | 0 | 2 | 3 | 11 |
| 12 (“FR- | 18 | 10 | 0 | 0 | 9.5 |
| 370 80”) | 18 | 20 | 1 | 2 | 11.5 |
| | 19 | 30 | 0 | 2 | 7.5 |
| | 19 | 40 | 0 | 2 | 09 |
| | 19 | 50 | 2 | 2 | 11 |
| | 18 | 100 | 1 | 3 | 11.5 |

### B 35/65 Cotton/Polyester Woven Fabric

A 35/65 cotton/polyester woven fabric specimen weighing 250 grams per square meter (grams/m²) was treated by padding with Formulation 12 (“FR-370_80”) in a Rapid lab padder (PAD MANGLE by RAPID).

The target add-on value was 30-40% by fabric weight with acceptable add-on between 30% and 34% by weight.

Thereafter, the fabric specimens were dried at 110° C. for 4-5 minutes, followed by curing at 170-185° C. for a further 7 minutes.

The fabric specimens were neutralized as described in the methods above.

The fabrics were laundered 5 to 100 times according to AATCC Standard Practice for Home Laundry at 60° C., bone dried and tested according to ASTM D 6413-08 vertical flame, 12 seconds ignition test. Results of the flammability resistance test (ASTM D6413-08 vertical flame test, 12 sec. ignition test) are provided in Table 15.

TABLE 15

| | | | 35/65 cotton/polyester (woven) | | |
|---|---|---|---|---|---|
| Co-for- | Sample # | | After | After | Char |
| mulation | (Add-on | Laundry | Flame | Glow | Length |
| # (name) | ~22%) | Cycles | sec. | sec. | cm. |
| Formulation | 20 | 0 | Fails | | |
| 12 (“FR- | | | | | |
| 370 80”) | | | | | |

The 35/65 cotton/polyester fabric failed the flammability test before laundry. Without being bound to any specific theory, it is thought that the formulation reacts only with the cotton component that comprises a smaller part of the 35/65 cotton/polyester fabric blend.

### C. 88/12 Cotton/Nylon Woven Fabric

A 88/12 cotton/nylon woven fabric specimen weighing 250 grams per square meter (grams/m²) was treated by padding with Formulation 12 (“FR-370_80”) in a Rapid lab padder (PAD MANGLE by RAPID).

The target add-on value was 30-40% by fabric weight with acceptable add-on between 30% and 34% by weight.

Thereafter, the fabric specimens were dried at 110° C. for 4-5 minutes, followed by curing at 170-185° C. for a further 7 minutes.

The fabric specimens were neutralized as described in the methods above.

The fabrics were laundered 5 to 100 times according to AATCC Standard Practice for Home Laundry at 60° C., bone dried and tested according to ASTM D 6413-08 vertical flame, 12 seconds ignition test. Results of the flammability resistance test (ASTM D6413-08 vertical flame test, 12 sec. ignition test) for the individual samples are provided in Table 16.

TABLE 16

| | | | 88/12 cotton/nylon (woven) | | |
|---|---|---|---|---|---|
| Co-for- | Sample # | | After | After | Char |
| mulation | (Add-on | Laundry | Flame | Glow | Length |
| # (name) | ~38-41%) | Cycles | sec. | sec. | cm. |
| Formulation | 21 | 0 | 0 | 5 | 15 |
| 12 (“FR- | 22 | 10 | 1 | 3 | 15.5 |
| 370 80”) | 23 | 20 | 1 | 3 | 11 |
| | 24 | 30 | 0 | 0 | 15 |
| | 25 | 40 | 0 | 0 | 14 |
| | 23 | 50 | 0 | 2 | 9 |
| | 21 | 100 | 0 | 2 | 15 |

The results obtained in Example 3 illustrate that the co-formulations of the invention show good performance in cotton rich cotton/synthetic fiber blends.

### Example 4

### Application of FR Co-Formulations to 100% Cotton Knit Fabric

### [Co-Formulations 17-18, (of the Invention); and Co-Formulations 14-16, (Comparative)]

100% cotton knit fabric specimen weighing 200 grams per square meter (grams/m²) was treated by padding it with a flame retardant formulation in a Rapid lab padder (PAD MANGLE by RAPID), as described in the methods above.

The target add-on value was 32% by weight for co-formulations 17 and 18 (of the invention); and for co-formulations 14-16 (comparative), with acceptable add-on between 30% and 34% by weight.

Thereafter, the fabric specimens were dried at 110° C. for 4-5 minutes, followed by curing at 170-185° C. for a further 7 minutes.

The fabric specimens were neutralized as described in the methods above.

### Results

### A. Co-Formulation 17 (“FR 370+Cymel 385”) (of the Invention)

The fabrics were laundered 10 to 100 times according to AATCC Standard Practice for Home Laundry at 60° C., bone dried and tested according to ASTM D 6413-08, 12 seconds ignition test.

Results of the flammability resistance test (ASTM D6413-08 vertical flame test, 12 sec. ignition test) for individual samples of co-formulation 17 (of the invention) are provided in Table 17.

TABLE 17

| | | | Cotton 100%(knit) | | |
|---|---|---|---|---|---|
| Co-for- | Sample # | | After | After | Char |
| mulation | (Add-on | Laundry | Flame | Glow | Length |
| # (name) | ~30-34%) | Cycles | sec. | sec. | cm. |
| Co- | 2571-96-2-1-1 | 0 | 0 | 0 | 4.5 |
| Formulation | 2571-96-2-1-2 | 10 | 0 | 0 | 11 |
| 17 (“FR | 2571-96-2-1-3 | 20 | 0 | 2 | 9.5 |
| 370 + | 2571-96-2-2-1 | 30 | 0 | 1 | 8.5 |
| cymel 385”) | 2571-96-2-2-2 | 40 | 0 | 1 | 9 |
| | 2571-96-2-2-3 | 50 | 0 | 2 | 10 |
| | 2571-96-2-2-4 | 60 | 0 | 3 | 9.5 |
| | 2571-96-2-4 | 70 | 0 | 1 | 10 |
| | 2571-96-2-3 | 80 | 0 | 3 | 12 |
| | 2571-96-2-3 | 90 | 0 | 1 | 11 |
| | 2571-96-2 | 100 | 0 | 2 | 12 |

The treated fabrics passed flammability before and after 100 laundries.

### B. Co-Formulation 18 (“FR 370+Madurit MW 830 75% WA”) (of the Invention)

Table 18 provides an overview of the test samples that were prepared with co-formulation 18 (“FR 370+Madurit MW 830 75% WA”) (of the invention) using 100% cotton knit fabric specimens.

TABLE 18

| | | | Cotton 100%(knit) | | |
|---|---|---|---|---|---|
| Co-for- | Sample # | | After | After | Char |
| mulation | (Add-on | Laundry | Flame | Glow | Length |
| # (name) | ~30-31%) | Cycles | sec. | sec. | cm. |
| Co- | 2544-01-2-1-0 | 0 | 0 | 0 | 10 |
| Formulation | 2544-01-2-1-1 | 5 | 0 | 0 | 10.5 |
| 18 (“FR | 2544-01-2-1-2 | 20 | 2 | 0 | 14 |
| 370 + | 2544-01-2-2-1 | 40 | 0 | 0 | 8.5 |
| Madurit | 2544-01-2-2-2 | 50 | 0 | 0 | 12 |
| MW 830 75 | 2544-01-2-2-3 | 60 | 0 | 0 | 12 |
| % WA”) | 2544-01-2-3-1 | 70 | 1 | 0 | 12 |
| | 2544-01-2-3-2 | 80 | 2 | 0 | 14 |
| | 2544-01-2-3-4 | 100 | 2 | 0 | 12.5 |

The treated fabrics passed flammability before and after 100 laundries.

### C. Co-Formulation 14 (“FR 370+Cymel 303”) (Comparative)

A fabric sample was laundered once according to AATCC Standard Practice for Home Laundry at 60° C., bone dried and tested according to ASTM D 6413-08 12 seconds ignition test.

Results of the flammability resistance test (ASTM D6413-08 vertical flame test, 12 sec. ignition test) for individual samples of Co-formulation 14 (“FR-370+cymel 303”) (comparative) before and after laundry are provided in Table 19.

TABLE 19

| | | | Cotton 100%(knit) | | | |
|---|---|---|---|---|---|---|
| Co- | | | After | After | Char | |
| formulation # | Sample # | Laundry | Flame | Glow | Length | |
| (name) | (Add-on ~38-40%) | Cycles | sec. | sec. | cm. | REMARKS |
| Co- | 2544-11-1-1 | 0 | 3 | 0 | 20 | FAIL |
| Formulation | 2544-11-1-5 | 1 | BEL¹ | | | FAIL |
| 14 | | | | | | |
| (“FR 370 + | | | | | | |
| cymel 303”) | | | | | | |

¹BEL = burnt entire length.

The treated fabrics failed flammability before and after single laundry.

### D. Co-Formulation 15 (“FR 370+Cymel 2000”) (Comparative)

Table 20 provides an overview of the test samples that were prepared with co-formulation 15 (“FR 370+cymel 2000”) (comparative) using 100% cotton knit fabric specimens.

Each sample was weighed before and after neutralization and the “add-on” percent values are presented in Table 20.

The “add-on” levels of the co-formulation were calculated based on the difference between the weight of the dry fabric before the treatment with the aqueous co-formulation 15, after the treatment with the aqueous co-formulation 15 and before neutralization, and after the treatment with the aqueous co-formulation 15 and after neutralization.

TABLE 20

| | | Add-on percent | Add-on percent |
|---|---|---|---|
| | | (%) after | (%) after |
| Co-for- | | treatment | treatment |
| mulation | | and before | and after |
| # (name) | Sample # | neutralization | neutralization |
| co- | 2544-13-1-1 | 30.06 | 17.31 |
| formulation | 2544-13-1-2 | 29.81 | 15.37 |
| 15 (“FR | 2544-13-1-3 | 28.84 | 16.34 |
| 370 + | 2544-13-1-4 | 28.63 | 14.88 |
| cymel 2000”) | 2444-13-1-5 | 28 | 16.14 |
| | 2544-13-1-6 | 28.74 | 15.89 |

The “add-on” levels after neutralization indicated partial bonding of co-formulation 15 to the fabric, in an amount insufficient to effectively reduce fabric flammability.

### E. Co-Formulation 16 (“FR 370+CARBODILITE E-02”) (Comparative)

Table 21 provides an overview of the test samples that were prepared with co-formulation 16 (“FR 370+CARBODILITE E-02”) (comparative) using 100% cotton knit fabric specimens.

Each sample was weighed before and after being subjected to neutralization and the “add-on” percent values are presented in Table 21.

The “add-on” levels of the co-formulation were calculated based on the difference between the weight of the dry fabric before the treatment with the aqueous co-formulation 16, after the treatment with the aqueous co-formulation 16 and before neutralization, and after the treatment with the aqueous co-formulation 16 and after neutralization.

TABLE 21

| | | Add-on percent | Add-on percent |
|---|---|---|---|
| | | (%) after | (%) after |
| Co-for- | | treatment | treatment |
| mulation | | and BEFORE | and AFTER |
| # (name) | Sample # | neutralization | neutralization |
| co- | 2544-12-2-1 | 27.67 | 11.62 |
| formulation | 2544-12-2-2 | 29.73 | 12.15 |
| 16 (“FR | 2544-12-2-3 | 28.76 | 11.91 |
| 370 + | | | |
| CARBODILITE | | | |
| E-02”) | | | |

The “add-on” levels after neutralization indicated partial bonding of co-formulation 16 to the fabric, in an amount insufficient to effectively reduce fabric flammability.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A flame retardant aqueous composition comprising:
a) a brominated phosphate ester of Formula I: 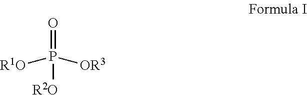
wherein each of R¹, R² and R³ is independently selected from brominated alkyl group; and
b) a melamine resin having a molecular weight above 150 gr/mole.

2. The flame retardant aqueous composition according to claim 1, wherein in the compound of Formula I each of R¹, R² and R³ is independently selected from brominated: methyl, ethyl, n-propyl, iso-propyl, butyl, iso-butyl, sec-butyl, tert-butyl, n-pentyl, iso-pentyl, neo-pentyl, tert-pentyl, n-hexyl, and iso-hexyl.

3. The flame retardant aqueous composition according to claim 1, wherein in the compound of Formula I each of R¹, R² and R³ is substituted with multiple bromine atoms.

4. The flame retardant aqueous composition according to claim 1, wherein the bromine content of the compound of Formula I is not less than 55% by weight of the molecule.

5. The flame retardant aqueous composition according to claim 1, wherein the compound of Formula I is tris(tribromoneopentyl)phosphate.

6. The flame retardant aqueous composition according to claim 1, wherein the melamine resin is selected from methylol-based melamine resin and formaldehyde-based melamine resin.

7. The flame retardant aqueous composition according to claim 6, wherein the formaldehyde-based melamine resin is alkyl modified melamine formaldehyde derivative.

8. The flame retardant aqueous composition according to claim 6, wherein the melamine resin is selected from partially methylated melamine formaldehyde resin, methylated melamine formaldehyde resin and methylated high imino melamine resin.

9. The flame retardant aqueous composition according to claim 1, wherein the composition is in a dispersion form, and wherein the composition further comprises one or more of dispersing agent, wetting agent, surfactant, softener.

10. The flame retardant aqueous composition according to claim 1, comprising from 15% to 25% by weight of the compound of Formula I based on the total weight of the composition; and 15% to 30% by weight of the melamine resin based on the total weight of the composition.

11. The flame retardant aqueous composition according to claim 10, comprising:
from 50 to 66% by weight of water;
from 19 to 22% by weight of brominated phosphate ester of Formula I;
from 19 to 28% by weight of melamine resin;
from 1 to 5% by weight of dispersing agent;
up to 1% by weight by weight of wetting agent; and
from 2 to 10% by weight of surfactant.

12. The flame retardant aqueous composition according to claim 11, further comprising a softener.

13. The flame retardant aqueous composition according to claim 12, comprising from 2 to 7% by weight of a softener.

14. The flame retardant aqueous composition according to claim 9, wherein the dispersing agent is selected from a nonionic dispersing agent or a ionic dispersing agent.

15. The flame retardant aqueous composition according to claim 14, wherein the nonionic dispersing agent is acrylate copolymer.

16. The flame retardant aqueous composition according to claim 9, wherein the surfactant is an anionic surfactant.

17. The flame retardant aqueous composition according to claim 16, wherein the anionic surfactant is a derivative of isotridecyl alcohol.

18. The flame retardant aqueous composition according to claim 9, wherein the wetting agent is selected from alkyl-substituted benzene sulfonic acid and alkyl-substituted naphthalene sulfonic acid.

19. The flame retardant aqueous composition according to claim 18, wherein the wetting agent is selected from sodium di-isopropyl naphthalene sulphonate and sodium di-butyl naphthalene sulphonate.

20. The flame retardant aqueous composition according to claim 1, wherein brominated phosphate ester of Formula I is wherein having a particle size distribution with d₅₀ equal to or below 5 μm and d₉₀ equal to or below 15 μm, having a particle size distribution with d₅₀ equal to or below 4 μm and d₉₀ equal to or below 10 μm.

21. A process for preparing a flame retardant aqueous composition according to claim 1, comprising dispersing the brominated phosphate ester of Formula I in water/aqueous medium to form a brominated phosphate ester dispersion, dispersing the melamine resin in water/aqueous medium to form a melamine resin dispersion, and combining the brominated phosphate ester dispersion and the melamine resin dispersion to form a homogeneous stable aqueous composition.

22. The process according to claim 21, wherein the brominated phosphate ester of Formula I is mixed with deionized water, dispersing agent and wetting agent, to form the brominated phosphate ester dispersion; and
wherein the melamine resin is mixed with a surfactant, optionally softener and optionally water, to form the melamine resin dispersion.

23. A method of imparting flame retardancy to a cellulose-based textile comprising treating the cellulose-based textile with a flame retardant aqueous composition according to claim 1.

24. The method according to claim 23, wherein the cellulose-based textile comprises at least 50% of cellulose fibers.

25. The method according to claim 24, wherein the cellulose-based textile comprises cellulose fibers and synthetic fibers.

26. The method according to claim 23, comprising:
(i) contacting the cellulose-based textile with the aqueous flame retardant composition comprising:
a) a brominated phosphate ester of Formula I: 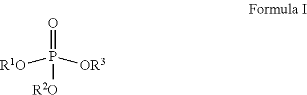
wherein each of R¹, R² and R³ is independently selected from brominated alkyl group; and
b) a melamine resin having a molecular weight above 150 gr/mole; and
(ii) heating the cellulose-based textile product.

27. The method according to claim 26, wherein the heating step comprises:
drying the cellulose-based textile product; and
curing the flame retardant composition.

28. The method according to claim 27, wherein the drying temperature is from about 100° C. to 120° C.; and the curing temperature is from about 140° C. to 190° C.

29. A flame retarded cellulose-based textile product comprising:
a) a cellulose-based textile;
b) a brominated phosphate ester of Formula I: 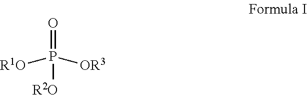
wherein each of R¹, R² and R³ is independently selected from brominated alkyl group; and
c) a melamine resin having a molecular weight above 150 gr/mole, above 180, above 300, above 400, above 500, above 600, above 700 gr/mole, preferably having a molecular weight of about 500 gr/mole, having a molecular weight above 500 gr/mole.

30. The flame retarded cellulose-based textile product according to claim 29, wherein the brominated phosphate ester of Formula I and the melamine resin are bound on the textile, incorporated into the textile or reacted with the textile.

31. The product according to claim 29, wherein the amount of the brominated phosphate ester of Formula I bound on and/or incorporated into the cellulose-based textile product is 5 to 20% by weight of the textile product.

32. The product according to claim 29, wherein the amount of the melamine resin bound on and/or incorporated into the cellulose-based textile product is 10 to 20% by weight, of the textile product.

33. The product according to claim 29, wherein the cellulose-based textile comprises at least 50% of cellulose fibers.

34. The product according to claim 29, wherein the cellulose-based textile comprises cellulose fibers and synthetic fibers.
